(19) United States
(12) Patent Application Publication
(10) Pub. No.: US 2013/0157528 A1
(43) Pub. Date: Jun. 20, 2013

(54) AMPHIBIOUS VEHICLE

(71) Applicant: GIBBS TECHNOLOGIES LTD, Warwickshire (GB)

(72) Inventor: Terence James Roycroft, Awhitu (NZ)

(73) Assignee: GIBBS TECHNOLOGIES LTD, Warwickshire (GB)

(21) Appl. No.: 13/732,856

(22) Filed: Jan. 2, 2013

Related U.S. Application Data
(63) Continuation of application No. 11/597,299, filed on Nov. 22, 2006, now Pat. No. 8,034,667.

(30) Foreign Application Priority Data
May 24, 2004 (GB) 0411546.5

(51) Int. Cl. B60F 3/00

(52) U.S. Cl. CPC B60F 3/003
USPC 440/12.52

(57) ABSTRACT

Amphibious vehicle 1 has at least two, preferably three, longitudinal vee sections 40 to 42 in its hull 2. Retractable wheels (21, FIG. 3) are provided; these may retract into discontinuities 8 to 11 in the hull. The wheels are retracted above the lowest point of the hull for marine use; and are protracted at least partly below the lowest point of the hull for land use. Where three vee sections are provided, the central vee 40 may depend lower than the side vees 41, 42; or vice versa. The hull may be a cathedral hull. The hull may have a deadrise of between 10 and 25 degrees. The vehicle ground clearance may be adjustable, for example from 0.10 m to 0.50 m. A four wheel drive power train may be provided, as shown in FIG. 4; for example, with a longitudinal engine 50, PTO 60, transmission 70, and transfer case 80.

### CROSS-REFERENCES TO RELATED APPLICATIONS

This application is a continuation of U.S. Ser. No. 11/597,229, filed on Aug. 2, 2007, which is based on PCT/GB2005/002061, filed on May 24, 2005, which claims priority to GB0411546.5, filed on May 24, 2004, which are incorporated by reference herein.

The present invention relates to an amphibious vehicle and, in particular, to an amphibious vehicle for off-road use in land mode.

In the past, designers of amphibious vehicles have focussed their efforts on optimising either on-water or on-land performance. As a result, either on-water performance has been sacrificed in order to give satisfactory on-land performance, or on-land performance sacrificed to give satisfactory on-water performance. The resulting vehicles are compromised to one degree or another.

To enable an amphibious vehicle to attain greater speed on water, it is desirable for the amphibious vehicle to be provided with a planing hull. Such a hull can be powered from standing where it is fully displaced to a speed where it can generate sufficient hydrodynamic lift to rise up out of the water and plane across the surface of the water.

Generally, for optimal performance, the surface of a planing hull should contain as few discontinuities as possible, as disruptions to the surface of the hull will increase drag and compromise both the hydrodynamic lift achievable and handling on water. However, the nature of an amphibious vehicle is such that it can require the surface of the hull to contain discontinuities, such as recesses within which components, for example, wheel assemblies, are located. Furthermore, the designers of planing hulls for watercraft usually adopt a dead rise angle of between 10 and 25 degrees. However, to date, it has been desirable to reduce as far as possible the dead rise angle in order to provide for adequate ground clearance when an amphibious vehicle is used on land. Such a low dead rise angle detrimentally affects the directional stability of the hull when planing on water.

In addressing the above problems, the applicant has developed hydrodynamic aids such as planing plates to help recover at least part of the hull form (as disclosed in the applicant's co-pending UK patent application no. 0311499.8) and strakes to improve directional stability of the hull when on the plane (as disclosed in the applicant's co-pending UK patent application no. 0311500.3).

The applicant has developed a high speed amphibious vehicle having off-road and utilitarian capability together with four-wheel drive. This type of high speed amphibian further compounds the problems identified above since a greater ground clearance is required and a bigger mass must be propelled up onto the plane. Surprisingly, this new amphibious capability has been achieved using a cathedral planing hull.

Accordingly, the present invention provides, in a first aspect, an amphibious vehicle operable in land and marine modes, the amphibious vehicle comprising:

a planing hull having three longitudinal V sections;

at least one discontinuity provided in the hull; and

at least one retractable wheel assembly located in the at least one discontinuity, wherein:

the at least one retractable wheel assembly is retracted above the lowest point of the hull when operating in marine mode and protracted below the lowest point of the hull when operating in land mode.

Preferred embodiments of the present invention will now be described by way of example only with reference to the accompanying drawings, in which:

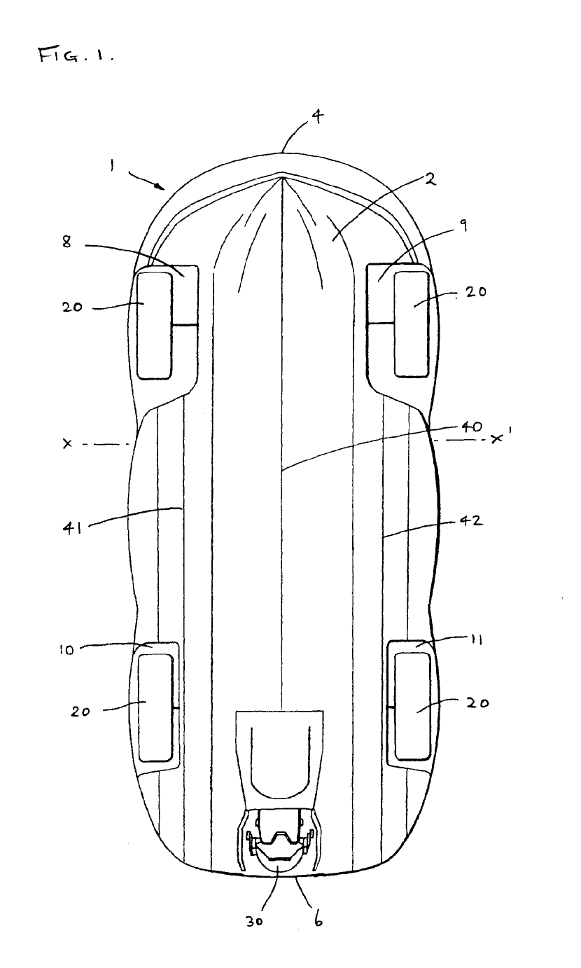

FIG. 1 is a schematic plan view of an underside of an amphibious vehicle according to the present invention;

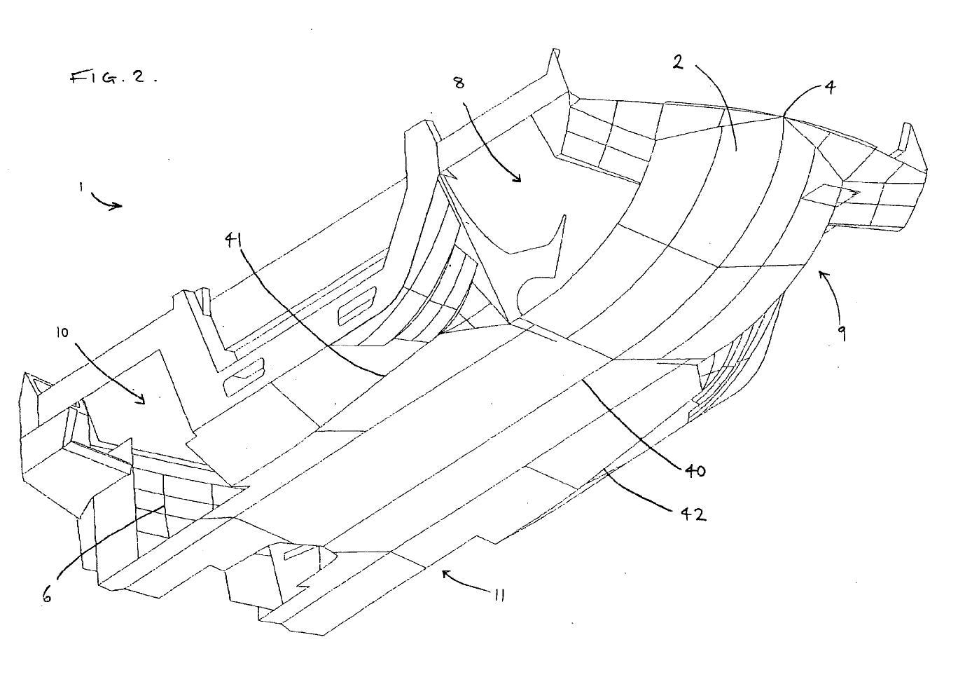

FIG. 2 is a schematic perspective view from below and one side of the amphibious vehicle of FIG. 1;

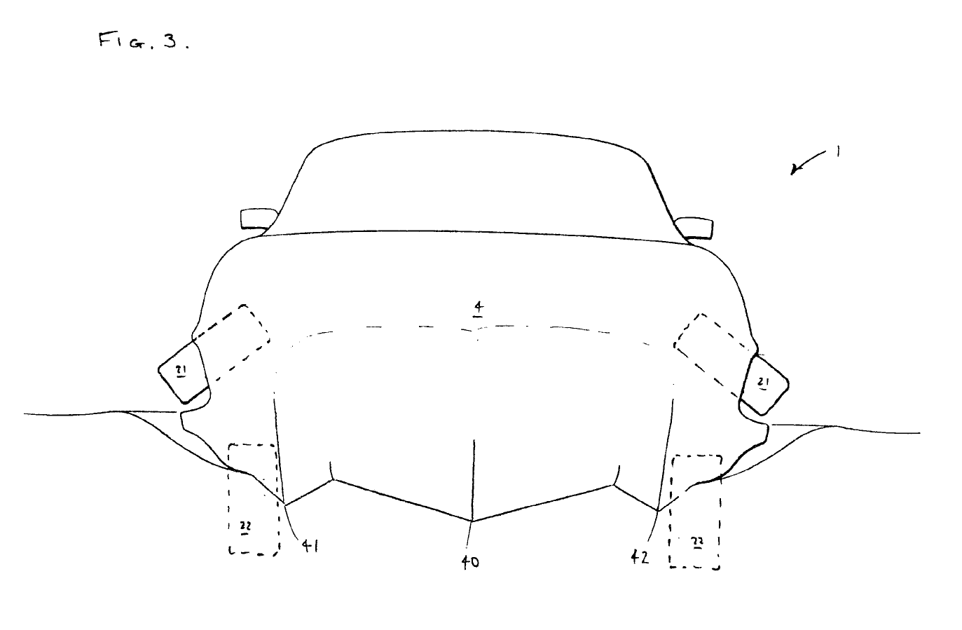

FIG. 3 is a cross-sectional view through the hull of the amphibious vehicle of FIG. 1, taken along the line x-x′; and

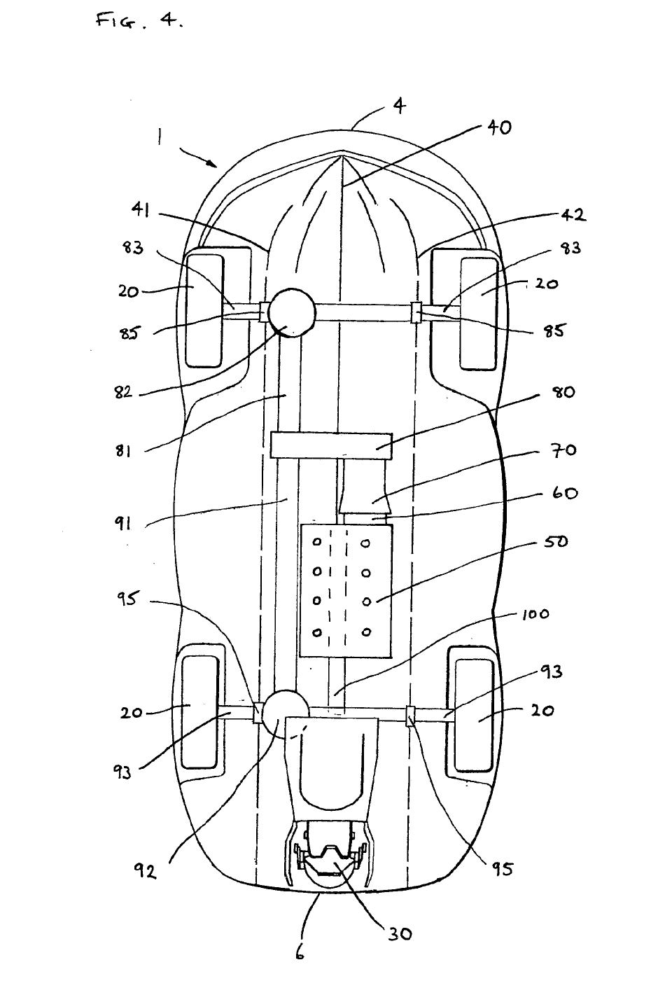

FIG. 4 is a schematic plan view of the hull illustrating a preferred power train arrangement.

Referring first to FIGS. 1 and 2, there is shown an amphibious vehicle 1 having a hull 2 comprising a forward bow end 4 and a rearward stern end 6. Provided on the underside of the hull 2 are a pair of forward wheel arches 8, 9 and a pair of rear wheel arches 10, 11. The wheel arches 8, 9, 10 and 11 each contain a retractable wheel assembly 20. A jet drive 30 is located at the rear of the vehicle 1 in the centre.

The hull 2 is of classic cathedral hull form having a central V section 40 and two further V sections 41, 42 each one displaced either side of the central V section 40. In FIG. 3, all three V sections 40, 41 and 42 can be seen to depend from the hull, the central V section 40 depending some 0.025 m deeper than the two side V sections 41, 42. Retractable wheel assemblies 20 are shown schematically both in the fully retracted position 21 and the fully protracted position 22. In the retracted position 21, all of the wheel 20 is above the lowest point of the hull. In the protracted position 22, at least part of the wheel 20 is below the lowest point of the hull.

A preferred embodiment of power train is illustrated in FIG. 4 (as described in the applicant's co-pending International patent application number WO 02/16158). An internal combustion engine 50 provides power for delivery to a sandwich power take-off unit 60. The sandwich power take-off unit 60 in turn delivers power to the gearbox 70 and directly to the jet drive 30 via marine drive shaft 100. A transfer box (or case) 80 transmits power from the gearbox 70 to a front propeller shaft 81 and to a rear propeller shaft 91. The front propeller shaft 81 and rear propeller shaft 91 are packaged longitudinally in the amphibious vehicle 1, slightly offset from the centre line of the vehicle 1 and lying in the central V section 40. Also located in the central V section 40 is a front differential 82 connected to the front propeller shaft 81 and a rear differential 92 connected to the rear propeller shaft 91.

Power from the front propeller shaft 81 and rear propeller shaft 91 is delivered via respective front and rear differentials 82, 92 to front wheel drive shafts 83 and rear wheel drive shafts 93 respectively, and on to each of the four retractable wheel assemblies 20. As such, in this preferred embodiment, the vehicle 1 is a four-wheel drive vehicle. The retracting wheel assemblies 20 may be as described in the applicant's U.S. Pat. No. 5,531,179. Also provided in line between the respective front and rear differentials 82, 92 and front and rear drive shafts 83, 93 are constant velocity joints 85, 95 (which in an alternative embodiment may take the form of a combination constant velocity joint and de-coupler with synchromesh as described in the applicant's International patent application no. WO 02/14092).

In use, when the hull 2 achieves sufficient through water speed, the resulting hydrodynamic lift causes the hull 2 to rise out of the water and onto the plane. In this condition the forward bow end 4 of the hull 2 lifts clear of the surface of the water and only the rearward planing surface of the hull 2 remains in contact with the water, albeit on the surface only. The planing surface of the vehicle 1 is thus constituted by the hull surface towards the rear of the vehicle 1, typically the portion of the hull 2 extending rearwardly from a point one third of the way along the length of the vehicle 1 from bow 4 to stern 6.

In order for the vehicle 1 to make the transition from its hull 2 being fully displaced and being non-displaced, i.e. planing, the through water speed of the vehicle 1 must be increased to achieve the necessary hydrodynamic lift. The triple V sections 40, 41, 42 are key in reducing the drag of the hull 2 and facilitating the necessary gain in speed of the vehicle 1. Once on the plane, the V sections 40, 41, 42 provide directional stability. However, these V sections 40, 41, 42 may be supplemented with strakes as discussed in the applicant's co-pending UK patent application no. 0311500.3. Furthermore, planing plates may be beneficially employed as described in the applicant's co-pending UK patent application no. 30311499.8.

1. An amphibious vehicle operable in land and marine modes, the amphibious vehicle comprising:
a cathedral hull having three longitudinal v hull sections positioned below a static waterline, wherein the three longitudinal v sections of the hull comprise a central v hull section and a side v hull section provided on either side of the central v hull section and wherein the central V hull section of the hull depends lower than the two side v hull sections;
at least one discontinuity provided in the hull that extends from below said static waterline to above said static waterline; and
at least one retractable wheel located in the at least one discontinuity, wherein:
at least one retractable wheel is retracted above the lowest point of the hull when operating in marine mode and at least partially protracted below the lowest point of the hull when operating in land mode, and wherein
one or more propulsion means is/are provided and can propel the vehicle to a speed where sufficient hydrodynamic lift is generated to enable the vehicle to plane.

2. An amphibious vehicle as claimed in claim 1, wherein the difference in height between the lowest depending point on the central v hull section of the hull and the lowest depending point of the two side V hull sections is substantially 0.025 m.

3. An amphibious vehicle as claimed in claim 1, wherein the at least one discontinuity provided in the hull is a wheel arch.

4. An amphibious vehicle operable in land and marine modes, the amphibious vehicle comprising:
a cathedral hull having a static waterline and three longitudinal V hull sections situated therebelow, wherein a central v hull section depends lower than two side v hull sections; and
at least one retractable wheel assembly, wherein:
the at least one retractable wheel is retracted to a position above said waterline and partially outside the periphery of the hull when operating in marine mode and protracted completely below the static waterline and at least partially below the lowest point of the hull when operating in land mode.

5. An amphibious vehicle as claimed in claim 4 further comprising at least one discontinuity provided in the hull, wherein the at least one retractable wheel assembly is located in the at least one discontinuity.

6. An amphibious vehicle as claimed in claim 1, further comprising one or more jet drives as a marine propulsion means.

7. An amphibious vehicle as claimed in claim 1, wherein one or more marine propulsion means is/are provided and can propel the vehicle to a speed where sufficient hydrodynamic lift is generated to enable the vehicle to plane.

8. An amphibious vehicle as claimed in claim 1, further comprising a four wheel drive powertrain.

9. An amphibious vehicle as claimed in claim 1, further comprising a mechanical transmission.

10. An amphibious vehicle as claimed in claim 1, further comprising at least one differential provided in one of the V hull sections.

11. An amphibious vehicle as claimed in claim 1, further comprising at least one differential provided in a central V hull section.

12. An amphibious vehicle as claimed in claim 1, wherein at least one of the V hull sections extends along substantially the entire length of the hull.

13. An amphibious vehicle as claimed in claim 1, wherein all of the V hull sections extends along substantially the entire length of the hull.

14. An amphibious vehicle operable in land and marine modes, the amphibious vehicle comprising:
a cathedral hull having three longitudinal V hull sections positioned below a static waterline, wherein the three longitudinal V sections of the hull comprise a central V hull section and a side V hull section provided on either side of the central V hull section and wherein the central V hull section of the hull depends lower than the two side V hull sections;
at least one discontinuity provided in the hull that extends from below said static waterline to above said static waterline; and
at least one retractable wheel assembly located in the at least one discontinuity, wherein:
the at least one retractable wheel assembly is retracted to a position above the static waterline and partially beyond a surface defined by the hull surrounding said discontinuity when operating in marine mode and protracted below the lowest point of the hull when operating in land mode.
